(19) United States
(12) Patent Application Publication
(10) Pub. No.: US 2022/0306201 A1
(43) Pub. Date: Sep. 29, 2022

(54) SUBFRAME

(71) Applicant: HONDA MOTOR CO., LTD., Tokyo (JP)

(72) Inventor: Yuho Ito, Wako-shi (JP)

(21) Appl. No.: 17/679,235

(22) Filed: Feb. 24, 2022

(30) Foreign Application Priority Data
Mar. 29, 2021 (JP) 2021-054968

(51) Int. Cl. B62D 21/03

(52) U.S. Cl. CPC B62D 21/03

(57) ABSTRACT

A subframe includes: a main body portion extending in a vehicle width direction; a left vehicle body support portion provided on a left side of the main body portion and supported by a vehicle body; and a right vehicle body support portion provided on a right side of the main body portion and supported by the vehicle body. The main body portion includes a seat portion to which a securing tool is connected, and a lateral rib extending in the vehicle width direction and projecting downward along a reference surface that passes through the left vehicle body support portion and the right vehicle body support portion and intersects a front-back direction. The seat portion is located to overlap the reference surface. A lower seat surface of the seat portion is surrounded by a peripheral wall projecting downward. The lateral rib is coupled to the peripheral wall.

### CROSS-REFERENCE TO RELATED APPLICATION

Priority is claimed on Japanese Patent Application No. 2021-054968, filed on Mar. 29, 2021, the contents of which are incorporated herein by reference.

### BACKGROUND

### Field of the Invention

The present invention relates to a subframe.

### Background

In the related art, a suspension member secured to a lower portion of a vehicle body is known (see Japanese Unexamined Patent Application, First Publication No. 2005-59813, for example).

### SUMMARY

However, there is room for improvement in rigidity of the suspension member described in Japanese Unexamined Patent Application, First Publication No. 2005-59813.

An object of an aspect of the present invention is to provide a subframe with high rigidity.

A subframe according to a first aspect of the invention includes: a main body portion extending in a vehicle width direction; a left vehicle body support portion provided on a left side of the main body portion and supported by a vehicle body; and a right vehicle body support portion provided on a right side of the main body portion and supported by the vehicle body, in which the main body portion includes a seat portion to which a securing tool is connected, and a lateral rib extending in the vehicle width direction and projecting downward along a reference surface that passes through the left vehicle body support portion and the right vehicle body support portion and intersects a front-back direction, the seat portion is located to overlap the reference surface, a lower seat surface of the seat portion is surrounded by a peripheral wall projecting downward, and the lateral rib is coupled to the peripheral wall.

With this configuration, the main body portion includes the seat portion to which the securing tool is connected and the lateral rib extending in the vehicle width direction and projecting downward along the reference surface that passes through the left vehicle body support portion and the right vehicle body support portion and intersects the front-back direction. The seat portion is located to overlap the reference surface. The lower seat surface of the seat portion is surrounded by the peripheral wall projecting downward. The lateral rib is coupled to the peripheral wall. It is thus possible to cause rigidity in the vicinity of the seat portion in the main body portion to continuously and moderately change. It is thus possible to effectively withstand a bending or torsion moment working on the subframe using the left vehicle body support portion and the right vehicle body support portion as a fulcrum. Therefore, it is possible to provide a subframe with high rigidity.

In a second aspect, the lateral rib may include a center rib passing through a center of the subframe in the vehicle width direction and coupling the seat portion to any one of the left vehicle body support portion and the right vehicle body support portion, and a side rib coupling the seat portion to another of the left vehicle body support portion and the right vehicle body support portion.

With this configuration, the lateral rib includes the center rib passing through the center of the subframe in the vehicle width direction and coupling the seat portion to any one of the left vehicle body support portion and the right vehicle body support portion and the side rib coupling the seat portion to the other of the left vehicle body support portion and the right vehicle body support portion. It is thus possible to effectively withstand a moment acting on the subframe using the vehicle body support portion as a fulcrum. Additionally, it is possible to compensate for a loss of rigidity of the subframe due to the presence of the seat portion.

In a third aspect, the peripheral wall may include a front peripheral wall formed at a front portion, the main body portion may include a front rib projecting downward from a front end, and the front peripheral wall may be coupled to the front rib, which is thicker than the lateral rib.

With this configuration, the peripheral wall includes a front peripheral wall formed at the front portion, the main body portion includes a front rib projecting downward from the front end, and the front peripheral wall is coupled to the front rib, which is thicker than the lateral rib. It is thus possible to effectively withstand a bending moment and a torsion moment acting on the subframe.

In a fourth aspect, the seat portion may include a side wall extending downward from an outer periphery of an upper seat surface of the seat portion and a side wall rib projecting upward and extending in the vehicle width direction from the side wall.

With this configuration, the seat portion includes the side wall extending downward from the outer periphery of the upper seat surface of the seat portion and the side wall rib projecting upward and extending in the vehicle width direction from the side wall. In this manner, it is possible to further enhance rigidity of the seat portion and to cause rigidity in the vicinity of the seat portion in the main body portion to continuously and moderately change. Additionally, it is possible to enhance rigidity of the subframe. In a fifth aspect, the main body portion may include, at a location further inward in the vehicle width direction than the seat portion, a torque rod support portion projecting upward and having an opening portion into which a torque rod is inserted, and the side wall rib may include a water drainage path between the side wall and the torque rod support portion.

With this configuration, the main body portion includes, at the location further inward in the vehicle width direction than the seat portion, the torque support portion projecting upward and having the opening portion into which the torque rod is inserted. Additionally, the side wall rib includes the water drainage path between the side wall and the torque rod support portion. In this manner, water poured on the surroundings of the side wall rib can be naturally discharged using gravity, and it is possible to prevent the water from remaining in the surroundings of the side wall rib.

In a sixth aspect, the lateral rib may be provided on a lower edge of the opening portion.

With this configuration, the lateral rib is provided on the lower edge of the opening portion. In this manner, it is possible to enhance rigidity of the seat portion and also to enhance rigidity of the torque rod support portion.

Therefore, it is possible to compensate for reduced rigidity due to formation of the seat portion, to compensate for reduced rigidity due to the opening portion of the torque rod support portion, and thereby to enhance rigidity of the entire subframe. According to an aspect of the invention, it is possible to provide a subframe with high rigidity.

### BRIEF DESCRIPTION OF THE DRAWINGS

FIG. 1 is a perspective view of a subframe in an embodiment according to an aspect of the invention from the upper front side.

FIG. 2 is a perspective view of the subframe in the embodiment from the lower front side.

FIG. 3 is a plan view of the subframe in the embodiment.

FIG. 4 is a bottom view of the subframe in the embodiment.

FIG. 5 is a perspective view of a seat portion in the embodiment from the lower side.

FIG. 6 is a perspective view of the seat portion in the embodiment from the upper side.

FIG. 7 is a sectional perspective view along the line A-A in FIG. 6.

### DESCRIPTION OF EMBODIMENTS

Hereinafter, a subframe 100 according to an embodiment of the invention will be described with reference to the drawings. In the drawings, the arrow FR represents the front side of a vehicle, the arrow RB represents the rear side of the vehicle, the arrow UP represents the upper side of the vehicle, the arrow DW represents the lower side of the vehicle, the arrow L represents the left side of the vehicle, and the arrow R represents the right side. The left-right direction of the vehicle may be referred to as a vehicle width direction. A center of the vehicle in the vehicle width direction may be referred to as an inner side while the directions away from the center of the vehicle in the vehicle width direction may be referred to as outer sides. The following description may be given by applying the same reference signs to the left and right constituent members.

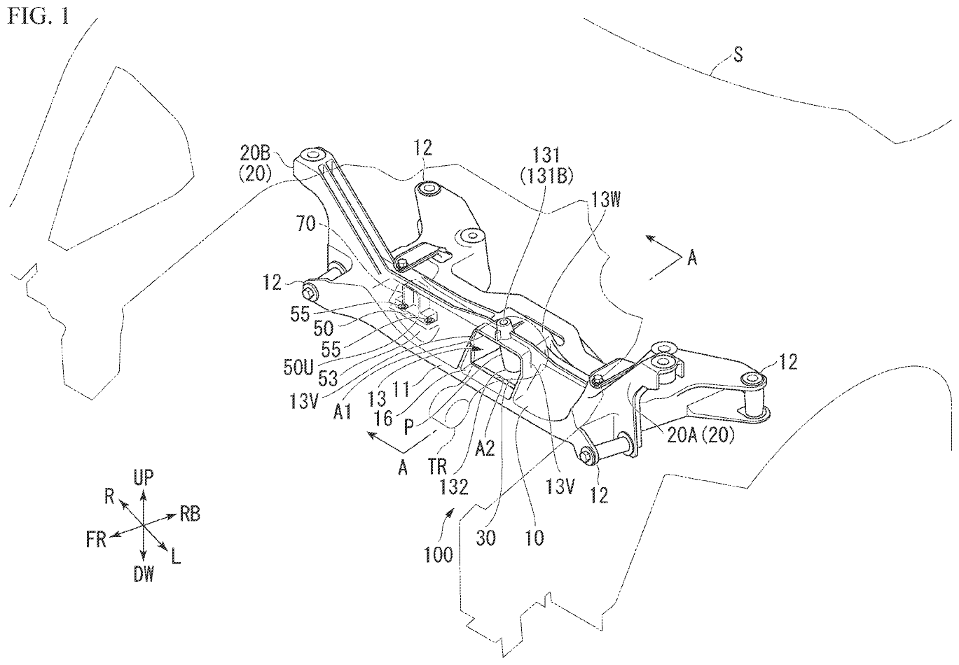

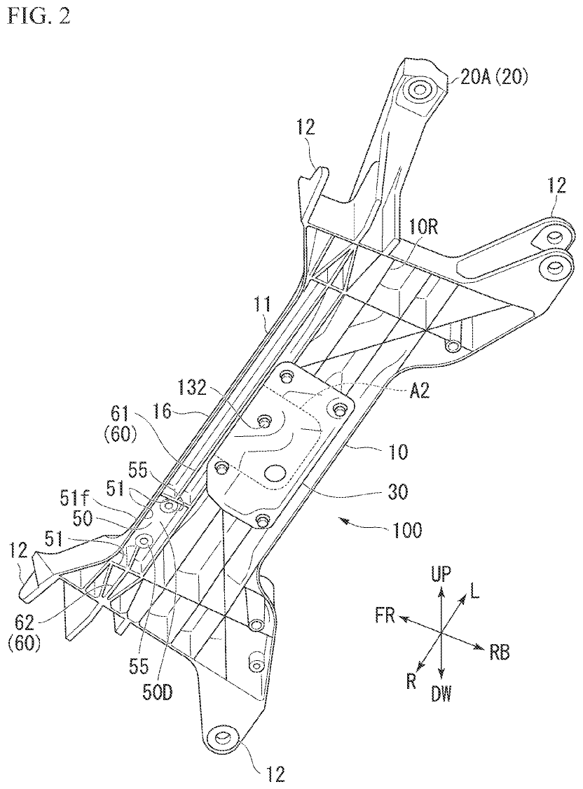

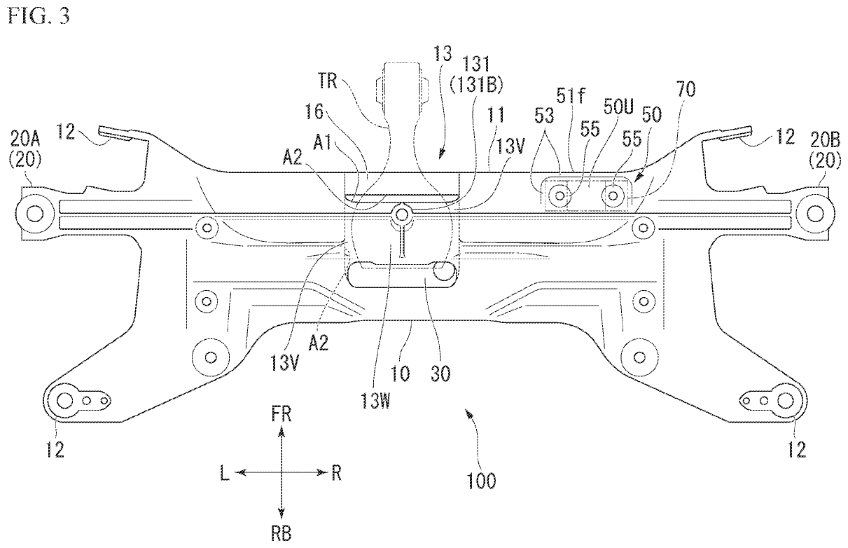

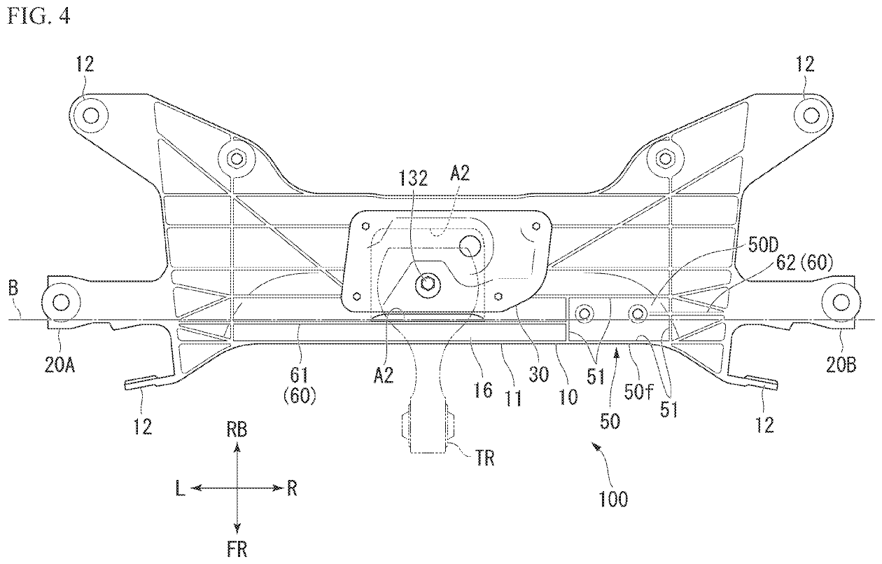

FIG. 1 is a perspective view of the subframe 100 according to an embodiment of the invention from the upper front side. FIG. 2 is a perspective view of the subframe 100 according to the embodiment from the lower front side. FIG. 3 is a plan view of the subframe 100 according to the embodiment. FIG. 4 is a bottom view of the subframe 100 according to the embodiment.

### (Subframe)

As illustrated in FIGS. 1 to 4, the subframe 100 is a member constituting a part of a skeleton of a vehicle along with a vehicle body S. The subframe 100 is provided below the vehicle body S.

The subframe 100 includes a main body portion 10 and a vehicle body support portion 20 supporting the main body portion 10 at the vehicle body S. The main body portion 10 and the vehicle body support portion 20 are integrally formed by a die-cast molding method, for example. The main body portion 10 and the vehicle body support portion 20 are made of an alloy of a non-iron metal such as aluminum, for example.

### (Main Body Portion)

The main body portion 10 has a structure extending in the vehicle width direction. The main body portion 10 is supported at the vehicle body S by the vehicle body support portion 20.

The main body portion 10 includes a suspension coupling portion 12 coupling a suspension device (not illustrated) that supports an axle (not illustrated) and a torque rod support portion 13. The main body portion 10 includes vehicle components such as an exhaust pipe, an electric cable, a stabilizer, and a steering gear box disposed as needed in a space between the main body portion 10 and the vehicle body.

The main body portion 10 includes a front rib 11 projecting downward from the front end. The front rib 11 projects downward along a plane that is perpendicular to the front-back direction and extends in the vehicle width direction. Preferably, the front rib 11 can be thicker than main body ribs 10R. Since the main body portion 10 includes the front rib 11 projecting downward from the front end, it is thus possible to enhance torsion rigidity and bending rigidity of the subframe 100.

The main body portion 10 includes the main body ribs 10R projecting downward. The main body ribs 10R are plate-shaped elements, and the plurality of main body ribs 10R may be provided at the main body portion 10. The plurality of main body ribs 10R may be disposed along a plane with normal lines with mutually different orientations and may be provided to intersect each other. It is thus possible to enhance torsion rigidity and bending rigidity of the subframe 100.

The suspension coupling portion 12 supports a suspension arm (not illustrated) of the suspension device with a hinge. The suspension coupling portion 12 is constituted by two plate-shaped elements branched into two parts from the main body portion 10, for example. Each of the two plate-shaped elements includes a hole for locking a shaft constituting the hinge. Two pairs of suspension coupling portions 12 may be provided on the left and right sides of the main body portion 10.

### <Torque Rod Support Portion>

The torque rod support portion 13 supports a torque rod TR coupled to a power unit, which is not illustrated. One end of the torque rod TR is coupled to the subframe 100 with a hinge via a bush (not illustrated). The other end of the torque rod TR is coupled to a power unit such as an engine. The torque rod support portion 13 is disposed at the center of the main body portion 10 in the vehicle width direction.

The torque rod support portion 13 projects upward and includes an opening portion A1 into which the torque rod TR is inserted. The torque rod support portion 13 is located further inward in the vehicle width direction than a seat portion 50, which will be described later.

Specifically, the torque rod support portion 13 projects upward from the upper surface of the main body portion 10. The torque rod support portion 13 forms a space in which one end of the torque rod TR can be accommodated. The torque rod support portion 13 includes a top plate 13W supporting one end of a shaft P supporting the torque rod TR and a side plate 13V. Note that the shaft P constitutes a hinge slidably supporting the torque rod TR.

The top plate 13W is a plate-shaped element including a substantially horizontal surface along the upper surface of the main body portion 10. The top plate 13W is located further upward than the upper surface of the main body portion 10. The top plate 13W has, on the lower side, a space in which the torque rod TR can be accommodated. The top plate 13W is formed integrally with the main body portion 10 via the side plate 13V extending upward from the main body portion 10. The top plate 13W includes a first shaft support portion 131 substantially at the center in plan view. A reinforcing plate 30 is provided below the top plate 13W away from the space for accommodating the torque rod TR and a lower opening portion A2. The first shaft support portion 131 provided at the top plate 13W supports one end of the shaft P. A second shaft support portion 132 provided at the reinforcing plate 30 supports the other end of the shaft P.

### (Vehicle Body Support Portion)

The vehicle body support portion 20 is a part that supports the main body portion 10 at the vehicle body. The vehicle body support portion 20 includes a left vehicle body support portion 20A provided on the left side of the main body portion 10 and supported at the vehicle body and a right vehicle body support portion 20B provided on the right side of the main body portion 10 and supported at the vehicle body. The left vehicle body support portion 20A and the right vehicle body support portion 20B are disposed to be away from each other and horizontally symmetrical.

The left vehicle body support portion 20A and the right vehicle body support portion 20B extend upward. Specifically, the left vehicle body support portion 20A and the right vehicle body support portion 20B extend obliquely outward to be separated from each other toward the upper side. The subframe 100 (main body portion 10) is bridged in the vehicle-width direction of the vehicle body in a state in which a space is formed between the vehicle body and the main body portion 10, by the left vehicle body support portion 20A and the right vehicle body support portion 20B. Note that the vehicle body support portion 20 may not be limited to the left vehicle body support portion 20A and the right vehicle body support portion 20B and the subframe 100 may further include more components.

### (Seat Portion and Lateral Rib)

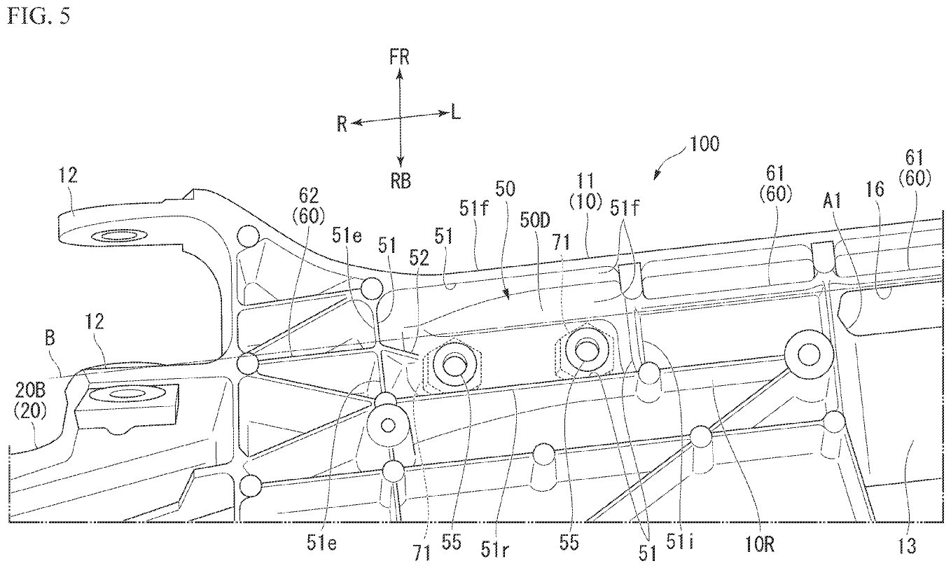

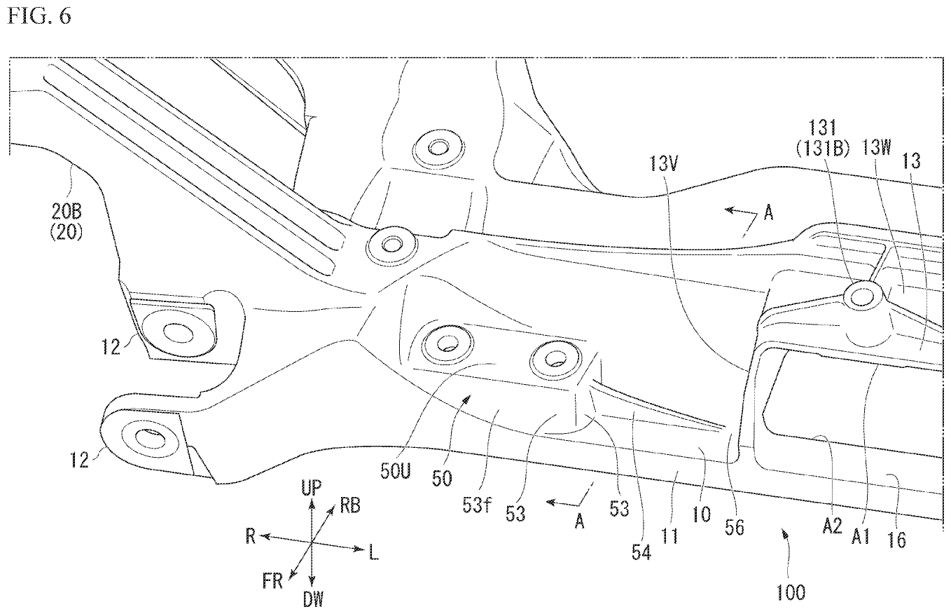

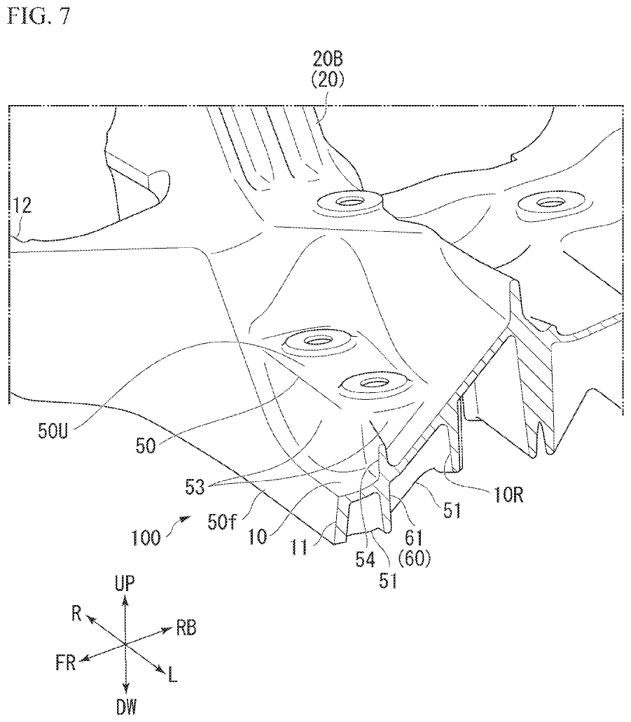

FIG. 5 is a perspective view of the seat portion 50 according to the embodiment from the lower side. FIG. 6 is a perspective view of the seat portion 50 according to the embodiment from the upper side. FIG. 7 is a sectional perspective view along the line A-A in FIG. 6.

As illustrated in FIGS. 4 and 5, the main body portion 10 includes the seat portion 50 to which a securing tool 71 is connected and a lateral rib 60 projecting downward along a reference surface B that passes through the left vehicle body support portion 20A and the right vehicle body support portion 20B and intersects the front-back direction and extending in the vehicle width direction. A bracket 70 is a member for attaching a vehicle component such as an exhaust pipe or an electric cable, for example, to the main body portion 10. The securing tool 71 is a member for securing the bracket 70 to the main body portion 10, such as a bolt and a nut, for example.

The lateral rib 60 extends along a plane that is substantially parallel with the reference surface B.

The seat portion 50 includes an upper seat surface 50U. The bracket 70 for attaching a vehicle component to the subframe 100 is placed on the upper seat surface 50U, for example. The bracket 70 is secured to the main body portion 10 with the securing tool 71 that passes through a through-hole 55 provided at the seat portion 50, connected to the seat portion 50, and projecting further downward than a lower seat surface 50D of the seat portion 50 as illustrated in FIG. 5.

Here, the seat portion 50 is located to overlap the reference surface B. In other words, the seat portion 50 is disposed on an extension line of the lateral rib 60 to interrupt a midpoint of the lateral rib 60. Also, the lower seat surface 50D of the seat portion 50 is surrounded by the peripheral wall 51 projecting downward. Moreover, the lateral rib 60 is coupled to the peripheral wall 51. In this manner, the seat portion 50 is provided to interrupt the midpoint of the lateral rib 60 that is linearly continuous from the left vehicle body support portion 20A to the right vehicle body support portion 20B in plan view and is also surrounded by the peripheral wall 51 coupled to the lateral rib 60. In other words, regardless of the presence of the seat portion 50 between the left vehicle body support portion 20A and the right vehicle body support portion 20B, rigidity of the seat portion 50 is enhanced by the peripheral wall 51, and the peripheral wall 51 is coupled to the lateral rib 60. It is thus possible to cause rigidity in the vicinity of the seat portion 50 in the main body portion 10 to continuously and mildly change. Therefore, it is possible to effectively withstand a bending or torsion moment acting on the subframe 100 using the left vehicle body support portion 20A and the right vehicle body support portion 20B as support points. Therefore, it is possible to provide the subframe 100 with high rigidity. Note that since the lower seat surface 50D of the seat portion 50 is not provided with the lateral rib 60, it is possible to secure a space where the securing tool 71 of the bracket 70 projecting downward from the lower seat surface 50D is accommodated.

Note that in order to further enhance rigidity of the seat portion 50, a small rib 52 ranging from the peripheral wall 51 to the lower seat surface 50D may be provided in the lower seat surface 50D of the seat portion 50. Preferably, the small rib 52 can be provided on an extension line of the lateral rib 60. In this manner, it is possible to continuously enhance rigidity in the vicinity of the peripheral wall 51 in the seat portion 50.

As illustrated in FIGS. 2, 4, and 5, the lateral rib 60 includes a center rib 61 passing through the center of the subframe 100 in the vehicle width direction and coupling the seat portion 50 to any one of the left vehicle body support portion 20A and the right vehicle body support portion 20B and a side rib 62 coupling the seat portion 50 and the other of the left vehicle body support portion 20A and the right vehicle body support portion 20B. In other words, the seat portion 50 is sandwiched with the lateral rib 60 coupled to the vehicle body support portion 20. It is possible to effectively withstand a moment acting on the subframe 100 using the vehicle body support portion 20 as a support point through such a relationship between the seat portion 50 and the lateral rib 60. Moreover, it is possible to make up for a loss of rigidity of the subframe 100 due to the presence of the seat portion 50.

The peripheral wall 51 includes a front peripheral wall 51f formed at the front portion as illustrated in FIG. 5. Additionally, the front peripheral wall 51f is coupled to the front rib 11, which is thicker than the lateral rib 60 and projects downward from the front end of the main body portion 10. In this manner, it is possible to enhance rigidity of the seat portion 50 and to cause rigidity in the vicinity of the seat portion 50 in the main body portion 10 to continuously and mildly change. Preferably, the front peripheral wall 51f can be coupled to the front rib 11 along the same plane, that is, linearly in plan view. In this manner, it is possible to effectively withstand a bending moment and a torsion moment acting on the subframe 100.

The peripheral wall 51 may be configured into an annular shape by a front peripheral wall 51f formed at the front portion, a rear peripheral wall 51r formed at the rear portion, an inner peripheral wall 51i formed on the inner side, and an outer peripheral wall 51e formed on the outer side as illustrated in FIG. 5. The peripheral wall 51 has a rectangular shape in plan view.

The seat portion 50 includes a side wall 53 extending downward from the outer periphery of the upper seat surface 50U of the seat portion 50 and a side wall rib 54 projecting upward and extending in the vehicle width direction from the side wall 53 as illustrated in FIGS. 6 and 7. In this manner, it is possible to further enhance rigidity of the seat portion 50. Note that the front side wall 53f located at the front portion of the seat portion 50 and extending in the vehicle width direction may also function as the front peripheral wall 51f of the peripheral wall 51. In this manner, it is possible to further enhance rigidity of the seat portion 50 and to cause rigidity in the vicinity of the seat portion 50 in the main body portion 10 to continuously and mildly change. Also, it is possible to enhance rigidity of the subframe 100.

The seat portion 50 includes a side wall 53 extending downward from the outer periphery of the upper seat surface 50U of the seat portion 50 and a side wall rib 54 projecting upward and extending in the vehicle width direction from the side wall 53 as illustrated in FIGS. 6 and 7. In his manner, it is possible to further enhance rigidity of the seat portion 50.

The side wall rib 54 includes a water drainage path 56 between the side wall 53 and the torque rod support portion 13 as illustrated in FIG. 6. The water drainage path 56 is at the lowest level in the surroundings of the side wall rib 54. As illustrated in FIG. 6, the water drainage path 56 may be formed between an end portion of the side wall rib 54 on the inner side and the side plate 13V by causing the side wall rib 54 to be disconnected at a midpoint without connecting it to the side plate 13V of the torque rod support portion 13. Note that the water drainage path 56 may be a hole provided in the side wall rib 54. In this manner, since the side wall rib 54 includes the water drainage path 56, it is possible to naturally discharge water from the surroundings of the side wall rib 54 due to gravity and to prevent the water from remaining in the surroundings of the side wall rib 54.

The lateral rib 60 is provided at the lower edge 16 of the opening portion A1 as illustrated in FIG. 5. In this manner, it is possible to enhance rigidity of the seat portion 50 and also to enhance rigidity of the torque rod support portion 13. Therefore, it is possible to make up for reduced rigidity due to formation of the seat portion 50, to make up for reduced rigidity due to the opening portion A1 (or the lower opening portion A2) of the torque rod support portion 13, and thereby to enhance rigidity of the entire subframe 100.

Note that the technical scope of the invention is not limited to the aforementioned embodiment and various modifications can be made without departing from the gist of the invention.

Furthermore, it is possible to replace components in the embodiment with other known components as needed, or the aforementioned modification examples may be appropriately combined, without departing from the gist of the invention.

What is claimed is:

1. A subframe comprising:
a main body portion extending in a vehicle width direction;
a left vehicle body support portion provided on a left side of the main body portion and supported by a vehicle body; and
a right vehicle body support portion provided on a right side of the main body portion and supported by the vehicle body,
wherein the main body portion includes
a seat portion to which a securing tool is connected, and
a lateral rib extending in the vehicle width direction and projecting downward along a reference surface that passes through the left vehicle body support portion and the right vehicle body support portion and intersects a front-back direction,
the seat portion is located to overlap the reference surface,
a lower seat surface of the seat portion is surrounded by a peripheral wall projecting downward, and
the lateral rib is coupled to the peripheral wall.

2. The subframe according to claim 1,
wherein the lateral rib includes
a center rib passing through a center of the subframe in the vehicle width direction and coupling the seat portion to any one of the left vehicle body support portion and the right vehicle body support portion, and
a side rib coupling the seat portion to another of the left vehicle body support portion and the right vehicle body support portion.

3. The subframe according to claim 1,
wherein the peripheral wall includes a front peripheral wall formed at a front portion,
the main body portion includes a front rib projecting downward from a front end, and
the front peripheral wall is coupled to the front rib, which is thicker than the lateral rib.

4. The subframe according to claim 1,
wherein the seat portion includes a side wall extending downward from an outer periphery of an upper seat surface of the seat portion and a side wall rib projecting upward and extending in the vehicle width direction from the side wall.

5. The subframe according to claim 4,
wherein the main body portion includes, at a location further inward in the vehicle width direction than the seat portion, a torque rod support portion projecting upward and having an opening portion into which a torque rod is inserted, and
the side wall rib includes a water drainage path between the side wall and the torque rod support portion.

6. The subframe according to claim 5,
wherein the lateral rib is provided on a lower edge of the opening portion.
